(19) United States
(12) Patent Application Publication
(10) Pub. No.: US 2009/0248536 A1
(43) Pub. Date: Oct. 1, 2009

(54) Twenty first century digital network

(76) Inventor: Daniel M. Rosenblum, (US)

Correspondence Address: DANIEL M. ROSENBLUM, POST OFFICE BOX 3377, GRAND CENTRAL STATION, NEW YORK, NY, 10163-3377, US

(21) Appl. No.: 12/079,235

(22) Filed: Mar. 26, 2008

(51) Int. Cl. G06Q 30/00; G06F 15/16

(52) U.S. Cl. 705/26; 709/200; 705/1

(57) ABSTRACT

A consumer driven internet technology based digital commercial network defined by specific licensing agreements between the network's manufacturers of hardware, the network's writer of operating system, the network's information carriers, and the network's administrator. The specific licensing agreements are writ and contracted to by the entities for the purpose and with the goal of maintaining the integrity of property rights in data transferred, processed, or transmitted on said network(s). By patenting the method/network design structure, a lynchpin for proprietary consumer driven digital commercial networks is created, unlike any utilized to date.

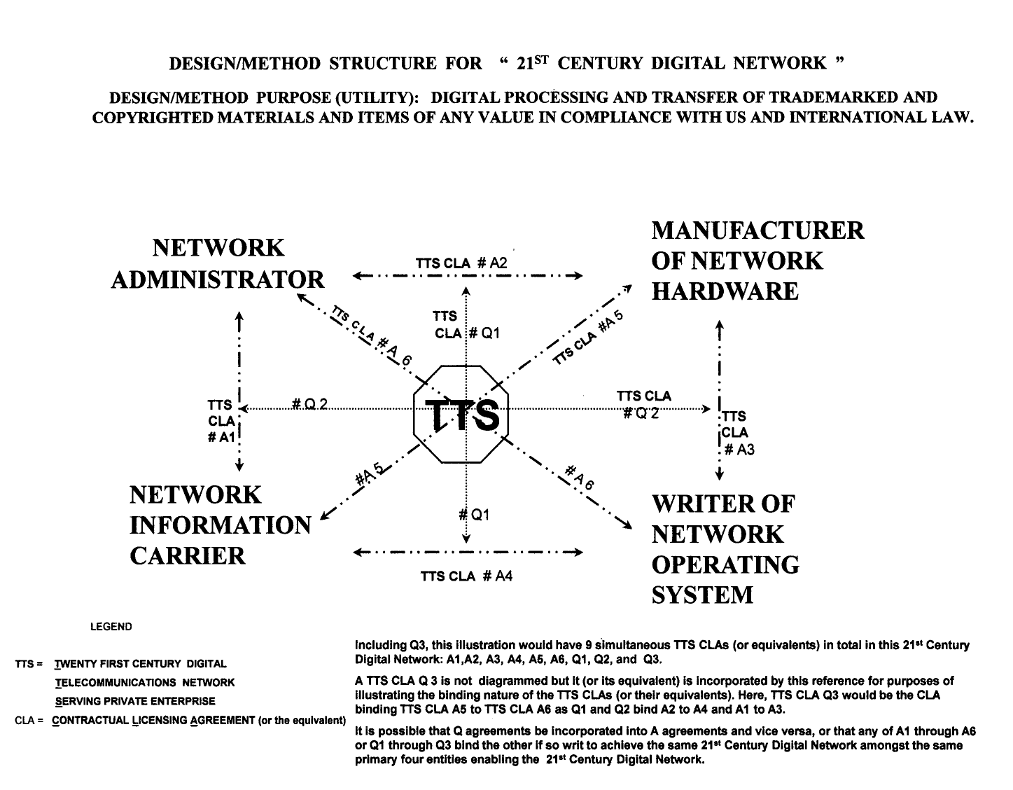

### CROSS-REFERENCE TO RELATED APPLICATIONS

A) This Application is derived from Provisional Application:
EFS ID: 1692285
Application Number: 60896866
Confirmation Number: 4501
Title of Invention: Twenty First Century Digital Network
First Named Inventor/Applicant Name: Daniel Mark Rosenblum
Customer Number: 68324
Application Type: Provisional
Time Stamp: 10:35:34
Filing Date: Mar. 23, 2007
Receipt Date: Apr. 18, 2007
Attorney Docket Number: TTSIndustries 1
Filer Authorized By:
Filer: Daniel Mark Rosenblum

B) Please Cross Reference To USPTO Trademark Applications Enclosed As Attachments:

1) Filing Date : Dec. 28, 2006, Ser. No. 77/072,392, Mark: 21st Century Digital and

2) Filing Date: Dec. 16, 2006, Ser. No. 77/021,219, Mark: Twenty First Century Digital

### BACKGROUND OF THE INVENTION

The field of invention is: Digital Commerce/Internet Commerce

Other attachments submitted herewith which in cross reference describe in greater detail the invention claimed:

A) Trademark Application-Filing date: Dec. 28, 2006, Ser. No. 77/072,392,
Mark: 21st Century Digital
Oct. 15, 2007 12 page filing

B) Trademark Application-Filing date: Dec. 16, 2006, Ser. No. 77/021,219,
Mark: Twenty First Century Digital
Aug. 7, 2007 seven page filing w/two addenda
Mar. 17, 2008 seven page filing
   (please cross reference to Trademark applications enclosed as attachment)

C) Electronic acknowledgement receipt for the provisional application precedent to instant filing

D) “Mock ‘21st Century Digital’ Bank Holding Company Application to Federal Reserve to Engage in Non-Banking Commercial Activities”

E) “Bank Holding Companies and Antitrust Regulation: Contemplating Market Power, Relationship Management, and Mixed Products in 2007”: This article advocates adding “Data Processing and Transmission” to Federal Reserve defined “Traditional Activities” for Bank Holding Companies

F) Drawing of the Invention

### BRIEF SUMMARY OF THE INVENTION

The business method and system for a “Twenty First Century Digital Network” is hereby claimed by inventor. The drawing submitted with the provisional application is attached hereto. Please note, additional attachments are listed below. The invention is a system and method for associating proprietary rights with a consumer driven internet technologies based commercial network defined through specific licensing agreements between the Network's Manufacturers of Hardware, Writers of Operating Systems, Information Carriers, and Network Administrators. By patenting the method or what the inventor refers to variously as the Design Structure or System of a Twenty First Century Digital Network, a lynchpin for proprietary consumer driven digital commercial networks is created, unlike any utilized to date. The design purpose is the digital transfer/processing/and/or transmission of trademarked and/or copyrighted data or any data for which ownership rights are maintained. The design purpose is to optimize security, reduce internet fraud and identity theft on internet through “TTS CLA's” as described in this application.

### BRIEF DESCRIPTION OF THE SEVERAL VIEWS OF THE DRAWING

The drawing labels the business method claimed by inventor as a structure for a network. At the top of the drawing the phrase “design purpose” briefly summarizes the purpose of the method depicted in the drawing. At the center of the drawing is a circle. The circle contains the words “Twenty First Century Digital Telecommunications Network Serving Private Enterprise Industries,” here after denoted by the acronym “TTS.” TTS, the center circle of the diagram results from specific contracts, denoted in the diagram as “TTS CLAs amongst and between the four entities listed on the four main corners of the drawing (listed as: 1) Manufacturer of Hardware, 2) Network Administrator, 3)Network Information Carrier, and 4) Writer of Network Operating System). The TTS CLAs are described as “21^{st} Century Digital Contractual Licensing Agreements. At the bottom of the drawing are two paragraphs which describe the nature and purpose of the TTS CLAs. Examples of business entities which might be well suited to perform the functions of the four component parts to the twenty first century digital network are listed following the abbreviation “eg” next to each of the four components on the diagram. Those examples are listed for purpose of illustration only, and are not listed as limiting the invention to participation by those entities only.

This brief description of the drawing should be read in context with the application as a whole.

### DETAILED DESCRIPTION OF THE INVENTION

Continuing from the brief description above, which describes a system on which four (4) entities contract through licensing agreements the utility of the invention is multifold. The inventor is convinced that the most important utility of the method described is the association of proprietary rights with national internet based networks which otherwise do not have proprietary rights and which are thereby exceedingly difficult to regulate for a nation built on capitalism. The invention does so taking into consideration free market capitalism, antitrust law, intellectual property law, etc as no other method is capable, in accordance with extant United States jurisprudence.

Surely other inventors can put forth other methods to attempt to associate proprietary rights with a national consumer driven commercial network. Thereafter, commercial entities can choose to operate on any proprietary model or non-proprietary model on which they might choose to operate. Likewise, consumers can choose to use any commercial digital network model which fulfills their needs. In the end, “21st Century Digital” networks are a species of networks defined by the contractual licensing agreements writ in accordance with:
The use of items Trademarked and/or Copyrighted in the United States of America for commercial purposes is subject to United States Federal Trade Commission, US Department of Justice, US Department of the Treasury, US Federal Reserve, US Securities and Exchange Commission, and other Federal, State, and Municipal governance, be it Executive, Legislative, or Judicial in nature as is provided by law. The TTS CLA's (Contractual Licensing Agreements) are anchored by/for/in 1) United States Governance, 2) any applicable patents, and 3) market considerations for the purpose of maintaining integrity of trademark and copyright processed, transmitted, or otherwise transferred on network. This, whilst serving business/consumer rights, needs, supply, and demand. Each/any individual network is owned by network administrators, carriers, manufacturers, writers, contract holders, contract providers and users pertaining thereto as agreed. In this manner proprietary rights are associated with national consumer driven commercial digital networks in accordance with us governance. Commerce between networks is likewise governed in accordance with the CLA's as anchored by/for/in 1) United States governance, 2) any applicable patents, and 3) market considerations.

The nomenclature is described and defined variously throughout. The instant application should suffice to enable the invention for third parties, notwithstanding the fact that the ‘TTS CLAs’ or ‘21^{st} Century Digital Contractual Licensing Agreements’ must be in accordance with US jurisprudence, as indicated throughout. A mark is utilized to describe and warrant that the CLAs are uniform, openly disclosed such that any ‘marked’ network (here given nomenclature of ‘21^{st} Century Digital Network’) can form at will, the mark being transferred, processed, and/or transmitted with such data to warrant that said data transferred, processed, and/or otherwise transmitted in accordance with the TTS CLAs on a 21^{st} Century Digital Network. The purpose is to afford the maximum possible security in maintaining the ownership rights/proprietary rights of the data transferred/transmitted,/processed as desired by the owner of the data.

The novelty is multifold. The utility is multifold. The end result of a patented design structure for a commercial consumer driven internet technologies network are proprietary networks on which manufacturers of hardware, writers of operating systems, information carriers, and network administrators all maintain their proprietary autonomy. The purpose of such 21st Century Digital Networks is commercial digital processing and transmission of data which the owners thereof and purchasers thereof desire the 21st Century Digital platform for said data processing and transmission as compared to some other platform or no proprietary platform. In doing so, fees generated via the patent are dedicated to research and development, as well as agreed upon dedications, for example, as articulated in attached “Mock Application to the Federal Reserve.”

### Please Cross Reference to Trademark Applications Enclosed as Attachments:

1) Filing Date: Dec. 28, 2006, Ser. No. 77/072,392, Mark: 21st Century Digital and

2) Filing Date: Dec. 16, 2006, Ser. No. 77/021,219, Mark: Twenty First Century Digital

This method varies considerably from the method by which a proprietary web site functions on the World Wide Web or Internet, and it differs too from such initiatives as AOL or MSN. Insofar as each of those are concerned, one autonomous business seeks to be the portal whose computer system consumers use for commercial purposes. Data in turn is transferred, transmitted and/or processed using the Internet, which is essentially unowned. The method claimed allows for the data to be transferred using substantially the same components as on the internet, but on an owned system which is warranted as such. To be certain, there are at present proprietary consumer driven commercial networks which transfer data—but none are formed using TTS CLAs. Nor are any formed specifically for the purpose of maintaining the integrity of the trademark or copyright associated with the data through licensing agreements made specifically amongst the four named network components in this declaration of the 21^{st} Century Digital Network invention, in compliance with US governance. Generally speaking, either hardware, or software, or information carrier has security mechanisms embedded in software, or hardware, or information carrier. No product is offered which embeds security for the purpose of maintaining the proprietary rights of trademarked or copyrighted data through a combination of hardware, software, information carrier, and network administrator utilizing licensing agreements as here claimed as invention. Furthermore, the “Twenty First Century Digital Networks” formed are owned by the licensing entities, thereby remaining autonomous. The patent is the lychpin. As described in the Mock Federal Reserve Application attached, the patent royalties shall be dedicated to research and development as well as a self regulatory organization. Entities have attempted to be the lead manufacturer of hardware or writer of operating system, or combine both, for similar purposes. But no invention nor system has come close to the system proposed with the marketable nomeNclature assigned, which in fact is part of the claimed invention. Any and all operating systems license with any hardware and carrier and administrator. The security therefore embedded in the network is therefore exponentially greater than any other security mechanism available to date.

Any manufacturers of hardware, writers of operating systems, information carriers, and network administrators can contract amongst themselves and exist simultaneously as Twenty First Century Digital Networks. The only time that patentable based royalties are collected are if the system is a 21st Century Digital Network—in turn, 21st Century Digital and TTS Industries will ratify the inter-entity and intra-entity contractual licensing agreements to the extent that those networks display themselves as 21st Century Digital Networks. Thereby, consumers will be aware of the system and recourses available. Owners of trademarks and copyrights will also be knowledgeable of the system on which their content is released. It is in the interest of the contracting entities to research and develop, etc.

In the end, such a system is stronger than software alone, hardware alone, information carrier alone embedded security.

For the reasons outlined, inter alia, in Mock Bank Holding Co and Section 106 publications by applicant Daniel Rosenblum, it is posited that Bank Holding Companies are particularly well suited to perform the function of 21st Century Digital Network Administrator. Note should be made, insofar as the novelty of the design structure or business method patent applied for that in 2008 the concept of a Bank Holding Company related Network Administrator for a consumer driven commercial digital network for the processing and transmission of trademarked and copyrighted data is unbespoke sans the reference to the method claimed as novel, unique, and useful. This is not to say that only bhcs qualify amongst the many entities capable of the position. However, this gleans light on the novelty, which may otherwise go challenged as non-unique.

No right is claimed to the myriad patented inventions which are utilized on a regular basis in internet technologies based transactions. The claim is for a specific combination which creates a network of utility given the economic and physical limitations under which the transition from non-digital commerce is evolving into non-physical commercial transactions as we enter the 21st Century.

1. Twenty First Century Digital Network

2. Twenty First Century Digital Network System

3. 21st Century Digital Network

4. 21st Century Digital Network System

5. A system superior to the unowned internet for purposes of processing and transmission of trademarked and copyrighted data

6. A system/method which is compatible with united states political-economy and market for achieving claim 5 above and is superior to other manners of achieving the same goal for many reasons, including but not limited to addressing antitrust and political concerns in achieving national internet security.

7. A system which is changeable over time. The TTS CLAs can be writ as described in the attached “Mock ‘21st Century Digital’ Bank Holding Company Application To Federal Reserve To Engage In Non-Banking Commercial Activities” to change and adapt in stages of months, years, and or decades.

8. A system which will allow for bank holding companies and other financial services companies to participate in the processing and transmission of trademarked and copyrighted data as described in the Attached “Bank Holding Companies And Antitrust Regulation: Contemplating Market Power, Relationship Management, And Mixed Products In 2007” article advocating adding “data processing and transmission” to federal reserve defined “traditional activies” for bank holding companies.

9. Business method design structure for a Twenty First Century Digital Network (applicant reserves right to refer to the same as a ‘21^{st} Century Digital Network.” The invention is a ‘21^{st} Century Digital Network.’ the applicant claims to have created both the invention and the nomenclature designating the invention. As such, please cross reference to USPTO Trademark Applications Ser. No. 77/021,219 and Ser. No. 77/072,392.

10. The nomenclature is described and defined variously throughout. The instant application should suffice to enable the invention for third parties, notwithstanding the fact that the ‘TTS CLAs’ or ‘21^{st} Century Digital Contractual Licensing Agreements’ must be in accordance with US jurisprudence, as indicated throughout. A mark is utilized to describe and warrant that the CLAs are uniform, openly disclosed such that any ‘marked’ network (here given nomenclature of ‘21^{st} Century Digital Network’) can form at will, the mark being transferred, processed, and/or transmitted with such data to warrant that said data transferred, processed, and/or otherwise transmitted in accordance with the TTS CLAs on a 21^{st} Century Digital Network. The purpose is to afford the maximum possible security in maintaining the ownership rights/proprietary rights of the data transferred/transmitted/processed as desired by the owner of the data.

11. A system which will allow for internet commerce to move to the next generation in digital commerce.

12. A system which will facilitate the collection of Federal and State taxes associated with electronic commerce.

13. A system which will enhance any and every manner of regulating digital commerce.

14. A system or method of associating proprietary rights with national consumer driven commercial internet technology based digital networks.

15. A system or method of associating proprietary rights with national consumer driven commercial internet technology based digital networks such that state and federal governance on such network is butressed by the proprietary interest that Twenty First Century Digital Network service providers have in maintaining said governance.

16. A system or method of associating proprietary rights with national consumer driven commercial internet technology based digital networks which otherwise remain anarchic and anachronistic in 21^{st} Century United States of America, where there are ownership rights associated with each and every product that Americans use except the finished product of the internet. That problem is holding back exponential value. In a capitalism based economy, ownership rights drive productivity, efficiency, and innovation.

17. A system or method of associating proprietary rights with national consumer driven commercial internet technology based digital networks such that warranties associated with the data transferred can be upheld with greater assurance.

18. A system or method of associating proprietary rights with national consumer driven commercial internet technology based digital networks such that technical support and technical service can be offered by and for said network.
